(19) United States
(12) Patent Application Publication
(10) Pub. No.: US 2022/0389334 A1
(43) Pub. Date: Dec. 8, 2022

(54) CONVERSION OF LIGHT NAPHTHA TO ENHANCED VALUE PRODUCTS IN AN INTEGRATED REACTOR PROCESS

(71) Applicant: Saudi Arabian Oil Company, Dhahran (SA)

(72) Inventors: Omer Refa Koseoglu, Dhahran (SA); Yaming Jin, Dhahran (SA)

(73) Assignee: Saudi Arabian Oil Company, Dhahran (SA)

(21) Appl. No.: 17/338,863

(22) Filed: Jun. 4, 2021

(51) Int. Cl. C10G 59/02; C10G 61/02; C10G 35/09; C10G 35/095

(52) U.S. Cl. CPC C10G 59/02; C10G 61/02; C10G 35/09; C10G 35/095; C10G 2400/30; C10G 2300/4025; C10G 2300/70

(57) ABSTRACT

An integrated process for conversion of a hydrocarbon stream comprising light naphtha to enhanced value products. The process includes passing the hydrocarbon stream through the first reactor, the first reactor being an isomerization reactor with an isomerization catalyst disposed therein to generate an isomerate stream comprising at least 20% by weight iso-paraffins. The process further includes passing the isomerate from the first reactor through a second reactor, the second reactor being an aromatization reactor with an aromatization catalyst disposed therein to generate an aromatic rich stream. The process finally includes passing the aromatic rich stream to an aromatic recovery complex to separate the aromatic rich stream into an aromatic fraction, a raffinate fraction comprising unconverted paraffins, and an aromatic bottoms fraction comprising C9+ hydrocarbons, where the aromatic fraction comprises benzene, toluene and mixed xylenes. An associated system for performing the process is also provided.

### TECHNICAL FIELD

The present disclosure relates to an integrated process and associated system for conversion of a hydrocarbon stream comprising light naphtha to enhanced value products.

### BACKGROUND

Aromatics such as BTX (benzene, toluene, and xylenes) are valuable chemicals frequently utilized in the production of many materials and formulation of many consumer goods. For example, BTX compounds are frequently utilized during the processing or production of petroleum products and during the production of consumer goods such as paints and lacquers, thinners, fuels, rubber products, adhesives, inks, cosmetics and pharmaceutical products. As such, their plentiful, efficient, and economical production is generally desirable.

The transformation of light naphtha or C₅-C₆ streams, which originate from refineries and gas plants, into value-added gasoline blending components such as BTX has been an ongoing challenge to researchers in academia and industry. Currently, the global demand for light naphtha is estimated at 378 million tons per year, with an annual growth rate of 1.9%. The primary use for light naphtha is as feed for steam crackers (60%) for the production of olefins (ethylene, propylene, and butenes), and as a blending stock for gasoline production (30%). However, the light naphtha stream has generally become an undesirable gasoline blending component because of its low octane number. This challenge has led refiners to seek novel approaches to upgrade this low-value stream into higher value products.

The current global demand for gasoline is 26.1 million barrels per day (bpd) or about 26% of global refined products. It is reported that the global gasoline demand showing an average annual growth rate of 2.3%. The gasoline pool typically receives product streams, such as isomerate, reformate, alkylate, and fluid catalytic cracking (FCC) gasoline, from different units in the refinery as well as the addition of renewable oxygenates. The composition of gasoline comprises different compounds of alkanes (paraffins), isoalkanes, olefins, naphthenes, and aromatics, known as PIONA. The production of branched alkanes from light naphtha has become one of the important targets in refineries. Under clean-fuel regulations, refiners must reduce the sulfur content in gasoline, which will add more challenges to use available volumes of low-octane light naphtha in the gasoline pool.

The transformation of light naphtha has been hindered by inertness of carbon-carbon and carbon-hydrogen bonds, which results in an elevated temperature and, therefore, unfavorable thermodynamics, low selectivity and yields, and high cost for commercial applications. As refiners continue to process lighter feeds, such as shale oil and condenstates, a process that cost effectively converts excess C₅-C₆ components is highly desirable.

### SUMMARY

Accordingly, there is a clear and long-standing need to provide an efficient and economical process for the production of BTX from a feedstock comprising substantial quantities of light naphtha.

In accordance with one or more embodiments of the present disclosure, an integrated process for conversion of a hydrocarbon stream comprising light naphtha to enhanced value products is disclosed. The process includes (i) providing the hydrocarbon stream comprising light naphtha to a first reactor; (ii) passing the hydrocarbon stream through the first reactor, the first reactor being an isomerization reactor with an isomerization catalyst disposed therein to generate an isomerate stream comprising at least 20% by weight iso-paraffins; (iii) passing the isomerate from the first reactor through a second reactor, the second reactor being an aromatization reactor with an aromatization catalyst disposed therein to generate an aromatic rich stream; and (iv) passing the aromatic rich stream to an aromatic recovery complex to separate the aromatic rich stream into an aromatic fraction, a raffinate fraction comprising unconverted paraffins, and an aromatic bottoms fraction comprising C9+ hydrocarbons, where the aromatic fraction comprises benzene, toluene and mixed xylenes.

In additional embodiments, the process further includes passing the isomerate from the first reactor through a dehydrogenation reactor with a dehydrogenation catalyst disposed therein to generate a dehydrogenated isomerate stream; and passing the dehydrogenated isomerate stream through the second reactor in lieu of the isomerate from the first reactor through the second reactor.

Additional features and advantages of the described embodiments will be set forth in the detailed description that follows. The additional features and advantages of the described embodiments will be, in part, readily apparent to those skilled in the art from that description or recognized by practicing the described embodiments, including the detailed description that follows as well as the drawings and the claims.

### BRIEF DESCRIPTION OF THE DRAWINGS

The following detailed description of specific embodiments of the present disclosure can be best understood when read in conjunction with the following drawings in which:

FIG. 1 is a schematic illustration of a prior art isomerization process;

FIG. 2 is a schematic illustration of one or more embodiments of the integrated refinery process of the present disclosure including an aromatization reactor; and

FIG. 3 is a schematic illustration of one or more embodiments of the integrated refinery process of the present disclosure including a dehydrogenation reactor.

Reference will now be made in greater detail to various embodiments, some embodiments of which are illustrated in the accompanying drawings. Whenever possible, the same reference numerals will be used throughout the drawings to refer to the same or similar parts.

### DETAILED DESCRIPTION

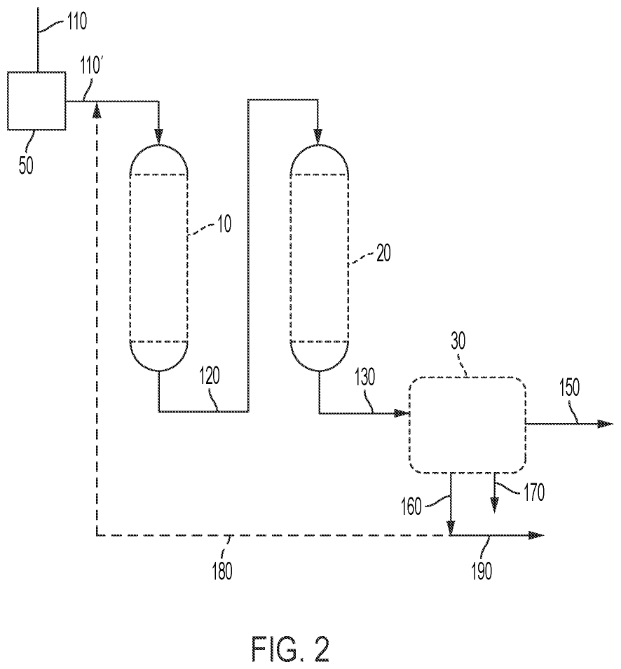

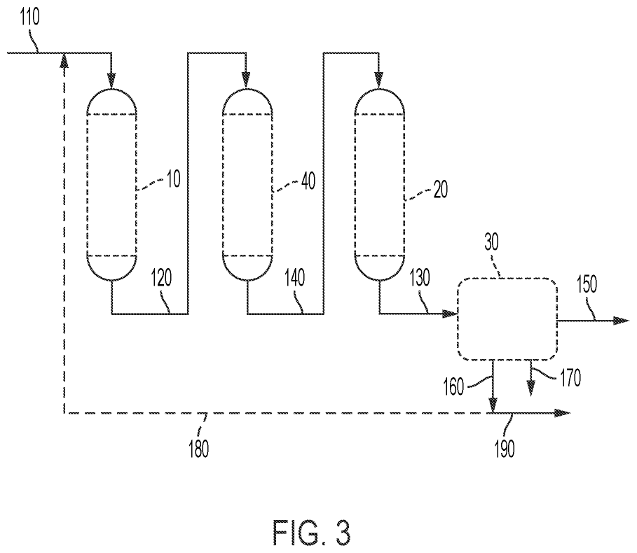

Reference will now be made in detail to embodiments of an integrated process and associated system for conversion of a hydrocarbon stream comprising light naphtha to enhanced value products of the present disclosure. While the system for conversion of a hydrocarbon stream comprising light naphtha to enhanced value products of FIGS. 2 and 3 are provided as exemplary, it should be understood that the present systems and methods encompass other configurations.

The processes and systems of the present disclosure provide increased conversion of light naphtha feedstocks to enhanced value products such as benzene, toluene, and xylenes (BTX). Specifically, the processes and systems of the present disclosure incorporate an isomerization procedure to isomerize the light naphtha feedstock in an initial processing step before passage of the resulting isomerate to further unit operations for conversion to the enhanced value products such as BTX.

It has been expectantly found that iso-paraffins convert to aromatics or olefins at a higher rate than normal paraffins. As olefins are intermediates in paraffin aromatization, an increase in the conversion of paraffins in a light naphtha feedstock may generate a commensurate increase in the ultimate generation of aromatics in a paraffin aromatization process.

In one or more embodiments, an integrated process for conversion of a hydrocarbon stream to enhanced value products includes providing a hydrocarbon stream 110 comprising light naphtha to a first reactor 10. The hydrocarbon stream 110 comprising light naphtha is passed through the first reactor 10 to generate an isomerate stream 120 comprising at least 20% by weight iso-paraffins. As such, the first reactor 10 is an isomerization reactor with an isomerization catalyst disposed therein to generate the isomerate stream 120. The isomerate stream 120 from the first reactor 10 may be passed through a second reactor 20 to generate an aromatic rich stream 130. The second reactor 20 is an aromatization reactor with an aromatization catalyst disposed therein to generate the aromatic rich stream 130. Finally, the aromatic rich stream 130 is passed to an aromatic recovery complex 30 to separate the aromatic rich stream 130 into an aromatic fraction 150, a raffinate fraction 160 comprising unconverted paraffins, and an aromatic bottoms fraction 170 comprising C9+ hydrocarbons. The aromatic fraction 150 comprises benzene, toluene and mixed xylenes (ortho-xylene, meta-xylene, and para-xylene.

In one or more further embodiments, an integrated process for conversion of a hydrocarbon stream to enhanced value products additionally includes a dehydrogenation reactor 40 with a dehydrogenation catalyst disposed therein to dehydrogenate the isomerate steam 120 and generate a dehydrogenated isomerate stream 140. Specifically, the integrated process for conversion of a hydrocarbon stream to enhanced value products may include providing a hydrocarbon stream 110 comprising light naphtha to a first reactor 10 and passing the hydrocarbon stream 110 through the first reactor 10 to generate an isomerate stream 120 comprising at least 20% by weight iso-paraffins. It is appreciated that the first reactor 10 is an isomerization reactor with an isomerization catalyst disposed therein to generate the isomerate stream 120. The isomerate stream 120 from the first reactor 10 may then be passed through the dehydrogenation reactor 40 to generate the dehydrogenated isomerate stream 140 which may then be passed through a second reactor 20 to generate an aromatic rich stream 130. It will be appreciated that the second reactor 20 is an aromatization reactor with an aromatization catalyst disposed therein to generate the aromatic rich stream 130. Finally, the aromatic rich stream 130 is passed to an aromatic recovery complex 30 to separate the aromatic rich stream 130 into an aromatic fraction 150, a raffinate fraction 160 comprising unconverted paraffins, and an aromatic bottoms fraction 170 comprising C9+ hydrocarbons. The aromatic fraction 150 comprises benzene, toluene and mixed xylenes.

Having disclosed the basic operation of the integrated process for conversion of a hydrocarbon stream comprising light naphtha to enhanced value products, each step of the embodiments of the integrated process are now provided in further detail.

### Hydrocarbon Feed

The hydrocarbon stream 110 comprises light naphtha. For purposes of this disclosure, light naphtha is considered to be paraffinic hydrocarbons containing 5 or 6 carbon atoms. Light naphtha generally has a boiling point range of 90 to 200° F. (approximately 32.2 to 93.3° C.). It is noted that the boiling points of n-pentane and n-hexane are 36° C. and 69° C. respectively. However in a refinery, due to inefficient separation, there may carried over material in a light naphtha stream resulting in a limited amount of higher carbon number molecules as well. Specifically, depending on the source of light naphtha, cut-points, and reactor efficiency, a light naphtha stream may be composed of normal paraffins, iso-paraffins, normal and iso-olefins, saturated and unsaturated naphthenes, and even small portion of aromatic compounds such as benzene and toluene.

In various embodiments, the hydrocarbon stream 110 may comprise light naphtha from various sources including crude oil, gas condensate, coal liquid, bio fuels, intermediate refinery processes, and their combinations.

In one or more embodiments, the hydrocarbon stream 110 comprises at least 75% by weight of normal paraffins and iso-paraffins having 5 or 6 carbon atoms. In various further embodiments, the hydrocarbon stream 110 comprises at least 76% by weight, at least 78% by weight, at least 80% by weight, at least 90% by weight, or at least 98% by weight of normal paraffins and iso-paraffins having 5 or 6 carbon atoms. Each such range is capped at 100% by weight of normal paraffins and iso-paraffins having 5 or 6 carbon atoms. The elevated level of paraffins in the hydrocarbon stream 110 provides ample reactants for conversion to enhanced value products including BTX.

Isomerization Reactor

In one or more embodiments, the first reactor 10 may be an isomerization reactor with an isomerization catalyst disposed therein to isomerize the hydrocarbon stream 110 fed to the first reactor 10. The catalytic bed reactor of the first reactor 10 may operate as a fixed bed reactor in one or more embodiments. In further embodiments, the catalytic bed reactor of the first reactor 10 may operate as a moving bed reactor.

In various embodiments, the isomerate stream 120 generated in the first reactor 10 may comprise at least 20% by weight, at least 25% by weight, at least 35% by weight, at least 40% by weight, or at least 50% by weight iso-paraffins. Alternatively stated, in various embodiments, the first reactor 10 may increase the iso-paraffins in the isomerate stream 120 by at least 5% by weight, at least 10% by weight, at least 15% by weight, at least 20% by weight, or at least 25% by weight iso-paraffins compared to the hydrocarbon feed 110.

The isomerization catalyst may be selected to efficiently isomerize n-paraffins to iso-paraffins. In accordance with various embodiments, the isomerization catalyst may be zeolitic type, metal oxide type such as sulfated zirconium oxide type, and chlorinated alumina type. Each isomerization catalyst additionally comprises one or more noble metals such as Pt or Pd or combinations of multiple noble metals.

In one or more embodiments the isomerization catalyst may comprise a platinum (Pt) on chlorinated alumina catalyst. Specifically, the isomerization catalyst may comprise a catalyst formed from platinum and aluminum chloride incorporated with an alumina base. Such a catalyst may comprise from 0.01 to 2.0 Weight percent platinum and aluminum chloride in an amount of from 0.1 to 15 weight percent based on the total catalyst. For example, in various embodiments, the Pt on chlorinated alumina catalyst may comprise from 0.05 to 1.5 weight percent platinum, 0.1 to 1.0 weight percent platinum, or 0.2 to 0.8 weight percent platinum and 0.1. to 10 weight percent, 0.1 to 5 weight percent, or 1 to 15 weight percent aluminum chloride. It will be appreciated that integration of platinum, aluminum chloride, or both at other ratios encompassed by the broadest ranges ar also envisioned but not explicitly delineated for brevity. In further embodiments, the platinum may be replaced with another metal selected from palladium, iridium, rhenium, and ruthenium.

In one or more embodiments and in accordance with the various configurations, the hydrocarbon stream 110 is provided to the first reactor 10 serving as the isomerization reactor at a liquid space velocity (LHSV) of 0.1 to 10 h⁻¹. In various further embodiments, the hydrocarbon stream 110 is provided to the first reactor 10 at a LHSV of 0.1 to 8 h⁻¹, 0.3 to 10 h⁻¹, 0.5 to 5 h⁻¹, 0.8 to 3 h⁻¹, 1 to 2 h⁻¹, or approximately 1.5 h ⁻¹. It will be appreciated that an increased LHSV results in a reduced n-paraffin isomerization on and a commensurate reduction in iso-paraffin. Similarly, a reduction in LHSV allows for equilibrium of n-paraffin and iso-paraffin based on the isomerization catalyst utilized resulting in an isomerate stream 120 with increased iso-paraffin content.

In one or more embodiments and in accordance with the various configurations, the first reactor 10 serving as the isomerization reactor may be operated at a reaction temperature of 20 to 300° C. In various embodiments, the first reactor 10 may be operated at a reaction temperature of 50 to 225° C., 100 to 180° C., 100 to 150° C., or approximately 125° C. It will be appreciated that isomerization is an equilibrium limited process where lower reaction temperature leads to higher conversion, but a lower reaction rate. As such, the optimum temperature is a compromise of the two effects. Further, the specific isomerization catalyst has an effect. For example, zeolitic catalysts are operable to temperatures of 300° C. where zirconia or chlorinated alumina are operable at temperatures of less than 200° C.

In one or more embodiments and in accordance with the various configurations, the first reactor 10 may be pressurized. The pressurization may be achieved with hydrogen. In various embodiments, the first reactor 10 is operated at a pressure of 10 to 100 bar, 20 to 70 bars, 32 to 38 bar, 33 to 37 bar, or approximately 35 bar.

The isomerization reactor forming the first reactor 10 may operate with a mixed feed of hydrogen and the hydrocarbon feed 110. In one or more embodiments and in accordance with the various configurations, the overall feed to the first reactor may be at a hydrogen to hydrocarbon molar ratio of 0.03:1 to 2:1. In various further embodiments, the overall feed to the first reactor may be at a hydrogen to hydrocarbon molar ratio of 0.03:1 to 1.5:1, 0.5:1 to 2:1, 1:1 to 2:1, or 1.5:1 to 2:1. It will be appreciated hydrogen assists in limiting coke formation, which deactivates the catalyst. The hydrogen partial pressure has to be high enough to be effective but excessive hydrogen will lead to operation difficulty and high cost.

Aromatization Reactor

In one or more embodiments, the second reactor 20 may be an aromatization reactor with an aromatization catalyst disposed therein to generate the aromatic rich stream 130. In accordance with the system configuration as illustrated in FIG. 2 where the isomerate stream 120 is passed directly to the second reactor 20, the isomerate stream 120 is converted to the aromatic rich stream 130 in the second reactor 20. Similarly, in accordance with the system configuration as illustrated in FIG. 3 where a dehydrogenation reactor 40 is positioned in the flow path between the first reactor 10 and the second reactor 20, the dehydrogenated isomerate stream 140 is converted to the aromatic rich stream 130 in the second reactor 20. The catalytic bed reactor of the second reactor 20 may operate as a fixed bed reactor in one or more embodiments. In further embodiments, the catalytic bed reactor of the second reactor 20 may operate as a moving bed reactor.

The aromatization catalyst may be selected to efficiently aromatize the feed stream to the second reactor 20. Specifically, aromatization catalyst may be selected to efficiently aromatize the isomerate stream 120 from the first reactor and to efficiently aromatize the dehydrogenated isomerate stream 140 from the dehydrogenation reactor 40. It will be appreciated that the aromatization catalyst may be selected to optimize performance based on if the feed stream to the second reactor 20 is the isomerate stream 120 from the first reactor or dehydrogenated isomerate stream 140 from the dehydrogenation reactor 40.

In accordance with various embodiments, the aromatization catalyst may include a metal oxide component dispersed on the surfaces of the zeolite support. The metal oxide component may include one or more oxides of metal elements selected from groups 4 to 13 of the International Union of Pure and Applied Chemistry (IUPAC) periodic table, such as groups 8 to 13 of the IUPAC periodic table. In one or more embodiments, the metal element of the one or more metal oxides may be a metal element selected from groups 4 to 13 and periods 4 to 6 of the IUPAC periodic table, such as period 4 of the periodic table. The metal element of the metal oxide may include, but is not limited to, titanium, vanadium, chromium, manganese, iron, cobalt, nickel, copper, zinc, gallium, molybdenum, palladium, silver, hafnium, tungsten, platinum, gold, or combinations of these metal elements. In one or more embodiments, the metal element of the one or more metal oxides may include gallium, zinc, iron, hafnium, or combinations of these metals. In one or more embodiments, the metal oxide may be gallium oxide.

In one or more embodiments the aromatization catalyst may comprise a gallium modified H-MFI type zeolite. Specifically, the aromatization catalyst may comprise a catalyst formed from gallium incorporated into a H-MFI type zeolite. Such a catalyst may comprise from 1 to 5 weight percent gallium (Ga) based on the total catalyst. For example, in various embodiments, the gallium modified H-MFI type zeolite catalyst may comprise from 1 to 4 weight percent gallium, 1 to 3 weight percent gallium, 1.5 to 2.5 weight percent gallium, 1.8 to 2.2 weight percent gallium, or approximately 2 weight percent gallium. It will be appreciated that integration of gallium at other ratios encompassed by the broadest ranges are also envisioned but not explicitly delineated for brevity. As previously indicted, in various embodiments, the gallium may be substituted with an alternative metal element while maintaining the remaining parameters of the disclosed gallium modified H-MFI type zeolite. In various embodiments, the silica to alumina ratio of the H-MFI type zeolite may vary from 20 to 100, 20 to 80, 20 to 50, or 20 to 30.

In one or more embodiments and in accordance with the various configurations, the isomerate stream 120 from the first reactor or the dehydrogenated isomerate stream 140 from the dehydrogenation reactor 40 is provided to the second reactor 20 serving as the aromatization reactor at a liquid space velocity (LHSV) of 0.1 to 10 h⁻¹. In various further embodiments, the hydrocarbon stream 110 is provided to the first reactor 10 at a LHSV of 0.1 to 8 h⁻¹, 0.3 to 10 h⁻¹, 0.5 to 5 h⁻¹, 0.8 to 3 h⁻, 0.8 to 2 h⁻¹, or approximately 1 h⁻¹. It will be appreciated that greater LHSV results in low aromatics yield while lesser LHSV favors formation of less desirable heavy aromatics.

In one or more embodiments and in accordance with the various configurations, the second reactor 20 serving as the aromatization reactor may be operated at a reaction temperature of 500 to 600° C. In various embodiments, the second reactor 20 may be operated at a reaction temperature of 500 to 575° C., 525 to 600° C., 525 to 575° C., or approximately 550° C. It will be appreciated that lesser temperature leads to lesser conversion while greater temperature results in faster catalyst deactivation.

In one or more embodiments and in accordance with the various configurations, the second reactor 20 may be operated at a pressure of 0.5 to 10 bar, 0.5 to 5 bar, 0.9 to 3 bar, or approximately 1 bar. It will be appreciated that lesser pressure favors aromatization reaction, but a minimum level of positive pressure is needed for practical operation.

Dehydrogenation Reactor

In one or more embodiments, the dehydrogenation reactor 40 has a dehydrogenation catalyst disposed therein to dehydrogenate the isomerate stream 120 from the first reactor 10 to generate the dehydrogenated isomerate stream 140. The catalytic bed reactor of the dehydrogenation reactor 40 may operate as a fixed bed reactor in one or more embodiments. In further embodiments, the catalytic bed reactor of the dehydrogenation reactor 40 may operate as a moving bed reactor.

The dehydrogenation catalyst may be selected to efficiently dehydrogenate the isomerate stream 120 and generate the dehydrogenated isomerate stream 140 having an increased olefin content. In accordance with various embodiments, the dehydrogenation catalyst may be zeolitic type or a chlorinated alumina type, each containing noble metals such as Pt or Pd or combinations of noble metals. Further, in various embodiments, the catalyst may comprise an active phase metal carried on a support containing an ultra-stable (US) Y-type zeolite, a Beta zeolite, or a mordenite zeolite. In various disclosed embodiments, the zeolite is referenced as a USY zeolite but a Beta zeolite or mordenite zeolite may be substituted in such disclosed embodiments.

In one or more embodiments the dehydrogenation catalyst may comprise an active phase metal carried on a support containing an ultra-stable (US) Y-type zeolite, in which a portion of aluminum atoms of the framework of said USW zeolite thereof is substituted with one or more of zirconium, titanium and hafnium atoms. In one or more embodiments, the support is alumina which acts as a binder. In one or more embodiments, zeolite may comprise 5 to 80 wt. % of the total catalyst.

In one or more specific embodiments, the USY zeolite is framework modified to contain zirconium and titanium atoms in place a portion of the aluminum atoms of the framework of said USY zeolite. In one or more embodiments, the USY zeolite may comprise 1 to 5 wt. % of zirconium and titanium on a zeolite basis.

In various embodiments, the active phase metal carried on the support containing the USY zeolite may be selected from Ru, Rh, Pd, Ag, Os, Ir, Pt, and Au. In one or more embodiments, the active phase metal carried on the support containing the USY zeolite is Pt in particular. In one or more embodiments, the active phase metal may comprise 0.1 to 1.5 wt. % of the total catalyst.

In one or more embodiments and in accordance with the various configurations, the isomerate stream 120 is provided to the dehydrogenation reactor 40 at a liquid space velocity (LHSV) of 1 to 10 h⁻¹. In various further embodiments, the isomerate steam 120 is provided to the dehydrogenation reactor 40 at a LHSV of 1 to 15 h⁻¹, 1 to 10 h⁻¹, 2 to 15 h⁻¹, 3 to 10 h⁻¹, 3 to 8 h⁻¹, or approximately 5 h⁻¹.

In one or more embodiments and in accordance with the various configurations, the dehydrogenation reactor 40 may be operated at a reaction temperature of 525 to 625° C. In various embodiments, the dehydrogenation reactor 40 may be operated at a reaction temperature of 525 to 600° C., 550 to 625° C., 550 to 600° C., or approximately 575° C. It will be appreciated that as temperature decreases the reactivity decreases but as temperature increases coke formation also increases.

In one or more embodiments and in accordance with the various configurations, the dehydrogenation reactor 40 may be pressurized. Pressurization may be achieved with hydrogen. In various embodiments, the dehydrogenation reactor 40 is operated at a pressure of 1 to 8 bar, 1.5 to 6 bar, 2 to 5 bar, or approximately 3 bar.

The dehydrogenation reactor 40 may operate with a mixed feed of hydrogen and the isomerate stream 120. In one or more embodiments and in accordance with the various configurations, the overall feed to the first reactor may be at a hydrogen to hydrocarbon molar ratio of 1:1 to 5:1. In various further embodiments, the overall feed to the first reactor may be at a hydrogen to hydrocarbon molar ratio of 1:1 to 4:1, 2:1 to 5:1, 2:1 to 4:1, or approximately 3:1.

Aromatic Recovery Complex

In one or more embodiments, the aromatic rich stream 130 is passed to the aromatic recovery complex 30 to separate the aromatic rich stream 130 into the aromatic fraction 150, the raffinate fraction 160, and the aromatic bottoms fraction 170. The aromatic fraction 150 comprises benzene, toluene and mixed xylenes and offers enhanced value compared to the hydrocarbon stream 110 comprising light naphtha. The raffinate fraction 160 comprises unconverted paraffins remaining from the hydrocarbon stream 110. The aromatic bottoms fraction 170 comprises C9+ hydrocarbons.

Various systems and techniques may be utilized in the aromatic recovery complex 30 for separating the aromatic rich stream 130 into various fractions and the present disclosure is not intended to be limited in nature to the specific arrangement of the aromatic recovery complex 30. Generally, the aromatic recovery complex 30 produces the aromatic rich stream 130 into the aromatic fraction 150, the raffinate fraction 160, and the aromatic bottoms fraction 170. While the aromatic fraction 150 is illustrated as a single stream for reduced complexity in FIGS. 2 and 3, it will be appreciated that the aromatic fraction 150 may be further separated into individual steams of benzene, toluene and mixed xylenes within the aromatic recovery complex 30.

There are many configurations of aromatic recovery complexes in general. In one or more embodiments, the aromatic recovery complex 30 may include, for example, a dehexanizer distillation column that removes lighter components and discharges a bottoms product stream. The bottoms product stream may be fed to a benzene distillation column that removes benzene overhead and discharges a bottoms stream having, for example, toluene, mixed xylenes, ethyl benzene, and C9+ aromatic compounds. In some instances, the overhead discharge may enter absorber and stripper columns to purify the benzene. The bottoms stream from the benzene distillation column may be processed in absorber and stripper columns to remove light components and further in distillation columns. The aforementioned absorber and stripper columns may involve solvent extraction.

This bottoms stream from the benzene distillation column may ultimately be processed in distillation columns to separate and recover toluene and various mixed xylenes. The distillation columns may include a toluene distillation column(s) and a xylene distillation column(s). A toluene distillation column may separate and discharge toluene overhead. The xylene distillation column may receive the bottoms discharge from the toluene distillation column, separate and discharge mixed xylenes overhead and discharge a heavy aromatics (C9+) bottoms stream, such as the aromatic bottoms fraction 170.

### Further Processing

In one or more embodiments, the integrated process for conversion of a hydrocarbon stream to enhanced value products additionally includes recycling at least a portion of the raffinate fraction 160 back to the first reactor 10 serving as an isomerization reactor. Recycling the raffinate fraction 160 recovers and effectively utilizes the unconverted paraffins present in the raffinate fraction 160. With reference to FIGS. 2 and 3, a raffinate recycle stream 180 directs a portion of the raffinate fraction 160 to the first reactor 10. The portion of the raffinate fraction 160 not rerouted as part of the raffinate recycle stream 180 is discharged from the integrated process as raffinate effluent stream 190. While FIGS. 2 and 3 illustrate the raffinate recycle stream 180 mixing with the hydrocarbon stream 110 prior to passage to the first reactor 10, it will be appreciated that the raffinate recycle stream 180 and the hydrocarbon stream 110 may be provided separately to the first reactor 10.

In one or more embodiments, the entirety of the raffinate fraction 160 may be recycled back to the first reactor 10 as the raffinate recycle stream 180. Similarly, in one or more embodiments, the entirety of the raffinate fraction 160 may be discharged from the integrated process as the raffinate effluent stream 190 with none of the raffinate fraction 160 recycled back to the first reactor 10. In various further embodiments, 1 to 99 weight percent, 1 to 50 weight percent, 1 to 25 weight percent, 25 to 99 weight percent, 50 to 99 weight percent, or 25 to 75 weight percent of the raffinate fraction 160 is recycled back to the first reactor 10 as the raffinate recycle stream 180.

In one or more embodiments, the integrated process for conversion of a hydrocarbon stream to enhanced value products additionally includes recovering the aromatic bottoms fraction 170 which comprises C9+ hydrocarbons and sending the aromatic bottoms fraction 170 to a fuel oil or gasoline pool.

In one or more embodiments, the integrated process for conversion of a hydrocarbon stream to enhanced value products additionally includes subjecting the hydrocarbon stream 110 comprising light naphtha to a desulfurization operation 50 prior to providing the generated desulfurized hydrocarbon stream 110′ comprising light naphtha to the first reactor 10. For simplicity and to illustrate the various system arrangements, the desulfurization operation 50 is illustrated only on FIG. 2. However, it will be appreciated and is contemplated by the inventors that such desulfurization operation 50 may also be included with the system illustrated in FIG. 3. The desulfurization operation 50 may be any of a variety of desulfurization process known to those skilled in the art. In one or more embodiments, the desulfurization operation 50 may include hydrodesulfurization in a hydrotreater.

In one or more embodiments, the integrated process for conversion of a hydrocarbon stream to enhanced value products the hydrocarbon stream 110 comprises less than 0.5 parts per million by weight (ppmw) of sulfur when provided to the first reactor 10. In various further embodiments, the hydrocarbon stream 110 comprises less than 0.3 ppmw of sulfur, less than 0.2 ppmw of sulfur, less than 0.1 ppmw of sulfur, or less than 0.05 ppmw of sulfur when provided to the first reactor 10. It will be appreciated that a hydrocarbon stream 110 which comprises a sulfur content greater than the prescribed quantity may be passed through the desulfurization operation 50 prior to providing the hydrocarbon stream 110 to the first reactor 10. However, if the hydrocarbon stream 110 comprises a sulfur content less than the prescribed quantity it may be passed directly to the first reactor without processing in the desulfurization operation 50 or alternatively may still be subjected to processing in the desulfurization operation 50 to further reduce the sulfur content of the hydrocarbon stream 110.

### EXAMPLES

The following examples illustrate features of the present disclosure but are not intended to limit the scope of the disclosure.

To verify the increase in conversion to value added aromatics products, such as benzene, toluene, and xylenes, with processes and systems in accordance with the present disclosure, laboratory scale demonstrations were completed for various inventive embodiments. Specifically, a light naphtha stream in accordance with the composition of Table 1 was processed using an integrated refinery process comprising an isomerization reactor, an aromatization reactor, and an aromatic recovery complex as Inventive Example 1 (in conformity with FIG. 2) and similarly a light naphtha stream of the same composition was processed using an integrated refinery process comprising an isomerization reactor, a dehydrogenation reactor, an aromatization reactor, and an aromatic recovery complex as Inventive Example 2 (in conformity with FIG. 3).

TABLE 1
Light Naphtha Feed Stream Composition (kg/h)

| | | Total | | | | |
|---|---|---|---|---|---|---|
| | | Feed | n-Par- | i-Par- | Naph- | Aro- |
| C# | Component | Stream | affins | affins | thenes | matics |
| 1 | Methane | | 0.00 | | | |
| 2 | Ethane | | 0.00 | | | |
| 3 | Propane | | 0.00 | | | |
| 4 | i-Butane | 0.11 | | 0.11 | | |
| 4 | n-Butane | 0.74 | 0.74 | | | |
| 5 | i-Pentane | 14.72 | | 14.72 | | |
| 5 | n-Pentane | 22.06 | 22.06 | | | |
| 5 | Cyclopentane | 2.61 | | | 2.61 | |
| 6 | 2.2-Mbutane | 0.40 | | 0.40 | | |
| 6 | 2.3-Mbutane | 1.73 | | 1.73 | | |
| 6 | 2-Methylpentane | 12.39 | | 12.39 | | |
| 6 | 3-Methylpentane | 10.28 | | 10.28 | | |
| 6 | n-Hexane | 20.87 | 20.87 | | | |
| 6 | Methylcyclopentane | 4.73 | | | 4.73 | |
| 6 | Cyclohexane | 3.34 | | | 3.34 | |
| 6 | Benzene | 3.52 | | | | 3.52 |
| 7 | 3-Ethylpentane | 0.01 | | 0.01 | | |
| 7 | 3.3-Methylpentane | 0.08 | | 0.08 | | |
| 7 | 2.4-Methylpentane | 0.77 | | 0.77 | | |
| 7 | 2.3-Methylpentane | 0.16 | | 0.16 | | |
| 7 | 2.2-Methylpentane | 0.38 | | 0.38 | | |
| 7 | 3-Methylhexane | 0.23 | | 0.23 | | |
| 7 | 2-Methylhexane | 0.47 | | 0.47 | | |
| 7 | 2.2.3-Methylbutane | 0.13 | | 0.13 | | |
| 7 | n-Heptane | 0.01 | 0.01 | | | |
| 7 | 1.1.diMethyl- | 0.09 | | | 0.09 | |
| | cyclopentane | | | | | |
| 7 | Methylcyclohexane | 0.00 | | | 0.00 | |
| 7 | Ethylcyclopentane | 0.00 | | | 0.00 | |
| 8 | n-Octane | 0.00 | 0.00 | | | |
| 8 | 2.2.4.Methylpentane | 0.00 | | 0.00 | | |
| 8 | 1.2.3.Methycyclo- | 0.00 | | | 0.00 | |
| | pentane | | | | | |
| 8 | Ethylcyclohexane | 0.00 | | | 0.00 | |
| 8 | C8-Others | 0.18 | | | 0.18 | |
| | TOTAL | 100.00 | 43.68 | 41.86 | 10.95 | 3.52 |

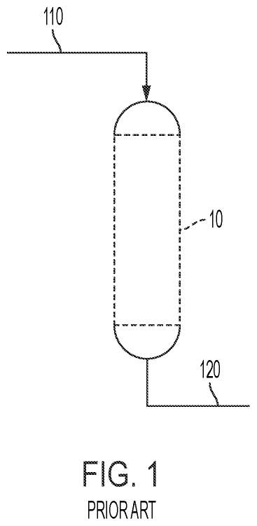

The isomerization reactor of each of Inventive Example 1 and Inventive Example 2 were operated under the same conditions and parameters such that identical isomerate streams were provided to the aromatization reactor of Inventive Example 1 and the dehydrogenation reactor of Inventive Example 2. That is the isomerization reactor 10 and the isomerate stream 2 as illustrated in each of FIGS. 1, 2 and 3 are synonymous between the various examples.

As the process of each of Inventive Example 1 and Inventive 2 include an initial isomerization process of the light naphtha feed stream which uniform between the Examples, such process is preemptively presented before addressing the additional aspects of each of Inventive Example 1 and Inventive Example 2. A feed stream of desulfurized light naphtha containing less than 0.1 ppmw of sulfur in accordance with the composition detailed in Table 1 was provided to the isomerization reactor. Such feed stream was then isomerized in the isomerization reactor at a temperature of 125° C., a pressure of 34.9 bar (35.6 kg/cm²), and a hydrogen to hydrocarbon molar ratio of 0.05 at a LHSV of 1.5 h⁻¹. Further, the catalyst provided in the isomerization reactor was a Pt/Alumina (chlorinated) catalyst (UOP I-82 from Honeywell UOP, Des Plaines, Ill.) The composition of the resulting isomerate stream is provided in Table 2.

TABLE 2
Isomerate Stream Composition (kg/h)

| | | Total | | | | |
|---|---|---|---|---|---|---|
| | | Isomerate | n-Par- | i-Par- | Naph- | Aro- |
| C# | Component | Stream | affins | affins | thenes | matics |
| 1 | Methane | 0.00 | 0.00 | | | |
| 2 | Ethane | 0.00 | 0.00 | | | |
| 3 | Propane | 0.00 | 0.00 | | | |
| 4 | i-Butane | 0.36 | | 0.36 | | |
| 4 | n-Butane | 0.39 | 0.39 | | | |
| 5 | i-Pentane | 28.00 | | 28.00 | | |
| 5 | n-Pentane | 10.15 | 10.15 | | | |
| 5 | Cyclopentane | 2.10 | | | 2.10 | |
| 6 | 2.2-Mbutane | 11.19 | | 11.19 | | |
| 6 | 2.3-Mbutane | 4.86 | | 4.86 | | |
| 6 | 2-Methylpentane | 15.18 | | 15.18 | | |
| 6 | 3-Methylpentane | 9.14 | | 9.14 | | |
| 6 | n-Hexane | 6.56 | 6.56 | | | |
| 6 | Methylcyclopentane | 5.01 | | | 5.01 | |
| 6 | Cyclohexane | 3.61 | | | 3.61 | |
| 6 | Benzene | 0.00 | | | | 0.00 |
| 7 | 3-Ethylpentane | 0.02 | | 0.02 | | |
| 7 | 3.3-Methylpentane | 0.11 | | 0.11 | | |
| 7 | 2.4-Methylpentane | 0.14 | | 0.14 | | |
| 7 | 2.3-Methylpentane | 0.18 | | 0.18 | | |
| 7 | 2.2-Methylpentane | 0.23 | | 0.23 | | |
| 7 | 3-Methylhexane | 0.21 | | 0.21 | | |
| 7 | 2-Methylhexane | 0.22 | | 0.22 | | |
| 7 | 2.2.3-Methylbutane | 0.06 | | 0.06 | | |
| 7 | n-Heptane | 0.11 | 0.11 | | | |
| 7 | 1.1.diMethyl- | 0.70 | | | 0.70 | |
| | cyclopentane | | | | | |
| 7 | Methylcyclohexane | 1.24 | | | 1.24 | |
| 7 | Ethylcyclopentane | 0.04 | | | 0.04 | |
| 8 | n-Octane | 0.00 | 0.00 | | | |
| 8 | 2.2.4.Methylpentane | 0.00 | | 0.00 | | |
| 8 | 1.2.3.Methycyclo- | 0.04 | | | 0.04 | |
| | pentane | | | | | |
| 8 | Ethylcyclohexane | 0.15 | | | 0.15 | |
| 8 | C8-Others | 0.00 | | | 0.00 | |
| | TOTAL | 100.00 | 17.21 | 69.90 | 12.89 | 0.00 |

### Inventive Example 1

Inventive Example 1 represents a refinery process in accordance with the system illustrated in FIG. 2. Specifically, Inventive Example 1 represents processing of the light naphtha stream as described in Table 1 sequentially through an isomerization reactor and an aromatization reactor. As previously described, the isomerization reactor was operated at a temperature of 125° C., a pressure of 34.9 bar (35.6 kg/cm2), and a hydrogen to hydrocarbon molar ratio of 0.05 over a Pt/Alumina (chlorinated) catalyst at a LHSV of 1.5 h⁻¹ to generate an isomerate stream having the composition detailed in Table 2.

Such isomerate stream was then subjected to aromatization in the aromatization reactor at a temperature of 550° C. and a pressure of 0.98 bar (1 kg/cm² at a LHSV of 1 h⁻¹. Further, the catalyst provided in the aromatization reactor was a gallium modified H-MFI type zeolite comprising 2% by weight gallium. Further the H-MFI type zeolite comprised a silica to alumina ratio of 30. The composition of the resulting aromatic rich stream is provided in Table 3. The presence of each component in the light naphtha and isomerate steams are also provided for ease of reference.

The gallium modified H-MFI type zeolite catalyst was prepared in accordance with the following procedure. In a vessel mix 9.7 grams of HZSM- 5 powder (such as CBV2314 (silica to alumina ratio of 23), or CBV 3024 (SAR 30) purchased from Zeolyst) was combined with 50 ml of deionized-water at room temperature. Subsequently, 1.2 grams of gallium nitrate was dissolved in 10 ml of Distilled-water. Under continuous stirring at 250 rpm, the gallium nitrate solution was added dropwise to the HZSM-5 zeolite solution. The mixture was kept at room temperature under continuous stirring for 2 to 4 hours. Subsequently, the mixture solution was heated up to 85° C. to evaporate the moisture. The partially wet solid mixture was then transferred to a drying oven at 100° C. and kept in the oven overnight . Further, the dried solid was ground to powder form and calcined at 550° C. for 5 hours in a muffle furnace. The calcined powder product was then pelletized and crushed to 30-50 mesh catalyst granules for reactivity testing.

TABLE 3
Inventive Example 1 Stream Compositions (kg/h)

| | | Light | | Aromatic | | | |
|---|---|---|---|---|---|---|---|
| | | Naphtha | Isomerate | Rich Steam | | | |
| C# | Component | Feed | Stream | Total | n-Paraffins | Olefins | Aromatics |
| 1 | Methane | | 0.00 | 7.20 | 7.20 | | |
| 2 | Ethane | | 0.00 | 8.50 | 8.50 | | |
| | Ethylene | | | 1.10 | | 1.10 | |
| 3 | Propane | | 0.00 | 11.10 | 11.10 | | |
| | Propylene | | | 1.20 | | 1.20 | |
| 4 | i-Butane | 0.11 | 0.36 | 0.00 | | | |
| 4 | n-Butane | 0.74 | 0.39 | 0.00 | | | |
| | Butenes | | | 0.00 | | | |
| 5 | i-Pentane | 14.72 | 28.00 | 0.00 | | | |
| 5 | n-Pentane | 22.06 | 10.15 | 0.00 | | | |
| 5 | Cyclopentane | 2.61 | 2.10 | 0.00 | | | |
| 6 | 2.2-Mbutane | 0.40 | 11.19 | | | | |
| 6 | 2.3-Mbutane | 1.73 | 4.86 | | | | |
| 6 | 2-Methylpentane | 12.39 | 15.18 | | | | |
| 6 | 3-Methylpentane | 10.28 | 9.14 | | | | |
| 6 | n-Hexane | 20.87 | 6.56 | | | | |
| 6 | Methylcyclopentane | 4.73 | 5.01 | | | | |
| 6 | Cyclohexane | 3.34 | 3.61 | | | | |
| 6 | Benzene | 3.52 | 0.00 | 13.8 | | | 13.8 |
| | Toluene | | | 27.7 | | | 27.7 |
| | Ethylbenzene | | | 0.00 | | | 0.00 |
| | m-Xylene | | | 9.10 | | | 9.10 |
| | p-Xylene | | | 4.20 | | | 4.20 |
| | o-Xylene | | | 4.50 | | | 4.50 |
| | C9+ aromatics | | | 11.60 | | | 11.60 |
| 7 | 3-Ethylpentane | 0.01 | 0.02 | | | | |
| 7 | 3.3-Methylpentane | 0.08 | 0.11 | | | | |
| 7 | 2.4-Methylpentane | 0.77 | 0.14 | | | | |
| 7 | 2.3-Methylpentane | 0.16 | 0.18 | | | | |
| 7 | 2.2-Methylpentane | 0.38 | 0.23 | | | | |
| 7 | 3-Methylhexane | 0.23 | 0.21 | | | | |
| 7 | 2-Methylhexane | 0.47 | 0.22 | | | | |
| 7 | 2.2.3-Methylbutane | 0.13 | 0.06 | | | | |
| 7 | n-Heptane | 0.01 | 0.11 | | | | |
| 7 | 1.1.diMethylcyclopentane | 0.09 | 0.70 | | | | |
| 7 | Methylcyclohexane | 0.00 | 1.24 | | | | |
| 7 | Ethylcyclopentane | 0.00 | 0.04 | | | | |
| 8 | n-Octane | 0.00 | 0.00 | | | | |
| 8 | 2.2.4.Methylpentane | 0.00 | 0.00 | | | | |
| 8 | 1.2.3.Methycyclopentane | 0.00 | 0.04 | | | | |
| 8 | Ethylcyclohexane | 0.00 | 0.15 | | | | |
| 8 | C8-Others | 0.18 | 0.00 | | | | |
| | TOTAL | 100.00 | 100.00 | 100.00 | 26.80 | 2.30 | 70.90 |

### Inventive Example 2

Inventive Example 2 represents a refinery process in accordance with the system illustrated in FIG. 3. Specifically, Inventive Example 2 represents processing of the light naphtha stream as described in Table 1 sequentially through an isomerization reactor, passing the isomerate stream to a dehydrogenation reactor, and passing the resulting olefinic naphtha stream to an aromatization reactor. As previously described, the isomerization reactor was operated at a temperature of 125° C., a pressure of 34.9 bar (35.6 kg/cm²), and a hydrogen to hydrocarbon molar ratio of 0.05 over a Pt/Alumina (chlorinated) catalyst at a LHSV of 1.5 h⁻¹ to generate an isomerate stream having the composition detailed in Table 2.

Such isomerate stream was then subjected to dehydrogenation in the dehydrogenation reactor at a temperature of 575° C., a pressure of 2.94 bar (3 kg/cm²), and a hydrogen to hydrocarbon molar ratio of 3 at a LHSV of 5 h⁻¹. Further, the catalyst provided in the dehydrogenation reactor was an ultra-stable Y-type zeolite with a portion of aluminum atoms of the framework substituted with titanium and zirconium in combination with platinum and an alumina binder. Pt was 0.2 wt. % on total catalyst basis. Zeolite content was 5 wt. %. Ti and Zr in the zeolite were 1 wt. % each.

The olefinic naphtha stream generated as the effluent of the dehydrogenation reactor was subsequently provided to an aromatization reactor operated at the same parameters as in Inventive Example 1. Specifically, the aromatization reactor was operated at a temperature of 550° C. and a pressure of 0.98 bar (1 kg/cm² at a LHSV of 1 h⁻¹ over a gallium modified H-MFI type zeolite having a silica to alumina ratio of 30 and comprising 2% by weight gallium to generate an aromatic rich stream.

The composition of the olefinic naphtha stream exiting the dehydrogenation reactor and the aromatic rich stream exiting the aromatization reactor are provided in Table 4. The presence of each component in the light naphtha and isomerate steams are also provided for ease of reference and are noted to conform to the corresponding streams in Inventive Example 1 (Table 3).

TABLE 4
Inventive Example 2 Stream Compositions (kg/h)

| | Light | | | Aromatic |
|---|---|---|---|---|
| | Naphtha | Isomerate | Olefinic | Rich |
| Component | Feed | Stream | Naphtha | Steam |
| n-Paraffins | 43.68 | 17.21 | 8.47 | 6.34 |
| i-Paraffins | 41.86 | 69.90 | 71.05 | 12.53 |
| Naphtenes | 10.96 | 12.89 | 17.51 | 0.00 |
| Olefins | 0.00 | 0.00 | 2.12 | 0.00 |
| Aromatics | 3.52 | 0.00 | 0.86 | 81.13 |
| TOTAL | 100.00 | 100.00 | 100.0 | 100.0 |

The aromatic rich stream in each of Inventive Example 1 and Inventive Example 2 were also provided to an aromatic recovery complex to separate the various components of the aromatic rich stream in to product fractions. Specifically, the aromatic rich stream in each of Inventive Example 1 and Inventive Example 2 were separated into a BTX (benzene, toluene, and xylenes) stream, a stream of unconverted light naphtha, and an aromatic bottoms stream (C9+). The composition of each stream is provided for Inventive Example 2 in Table 5.

TABLE 5
Aromatic Recovery Complex Products - Inventive Example 2

| | Aromatic | | Unconverted | Aromatic |
|---|---|---|---|---|
| | Rich | | Light | Bottoms |
| Component | Steam | BTX | Naphtha | (C9+) |
| n-Paraffins | 6.34 | 0.00 | 29.10 | 0.00 |
| i-Paraffins | 12.53 | 0.00 | 0.00 | 0.00 |
| Naphtenes | 0.00 | 0.00 | 0.00 | 0.00 |
| Olefins | 0.00 | 0.00 | 0.00 | 0.00 |
| Aromatics | 81.13 | 59.30 | 0.00 | 11.60 |
| TOTAL | 100.00 | 59.30 | 29.10 | 11.60 |

It should now be understood the various aspects of the integrated process and system for conversion of a hydrocarbon stream comprising light naphtha to enhanced value products are described and such aspects may be utilized in conjunction with various other aspects.

According to a first aspect, an integrated process for conversion of a hydrocarbon stream comprising light naphtha to enhanced value products includes (i) providing the hydrocarbon stream comprising light naphtha to a first reactor; (ii) passing the hydrocarbon stream through the first reactor, the first reactor being an isomerization reactor with an isomerization catalyst disposed therein to generate an isomerate stream comprising at least 20% by weight iso-paraffins; (iii) passing the isomerate from the first reactor through a second reactor, the second reactor being an aromatization reactor with an aromatization catalyst disposed therein to generate an aromatic rich stream; and (iv) passing the aromatic rich stream to an aromatic recovery complex to separate the aromatic rich stream into an aromatic fraction, a raffinate fraction comprising unconverted paraffins, and an aromatic bottoms fraction comprising C9+ hydrocarbons, where the aromatic fraction comprises benzene, toluene and mixed xylenes.

A second aspect includes the process of the first aspect in which in which the process further comprises passing the isomerate from the first reactor through a dehydrogenation reactor with a dehydrogenation catalyst disposed therein to generate a dehydrogenated isomerate stream; and passing the dehydrogenated isomerate stream through the second reactor in lieu of the isomerate from the first reactor through the second reactor.

A third aspect includes the process of the first or second aspect in which the process further comprises recycling at least a portion of the raffinate fraction comprising unconverted paraffins back to the isomerization reactor.

A fourth aspect includes the process of any of the first through third aspects in which the process further comprises recovering the aromatic bottoms fraction comprising C9+ hydrocarbons and sending aromatic bottoms fraction comprising C9+ hydrocarbons to a fuel oil or gasoline pool.

A fifth aspect includes the process of any of the first through fourth aspects in which the hydrocarbon stream comprises at least 75% by weight of normal paraffins and iso-paraffins having 5 or 6 carbon atoms.

A sixth aspect includes the process of any of the first through fifth aspects in which the process further comprises subjecting the hydrocarbon stream to a desulfurization operation prior to providing the hydrocarbon stream comprising light naphtha to the first reactor.

A seventh aspect includes the process of any of the first through sixth aspects in which the hydrocarbon stream comprises less than 0.5 parts per million of sulfur by weight when provided to the first reactor.

An eighth aspect includes the process of any of the first through seventh aspects in which the isomerization catalyst comprises a Pt on chlorinated alumina catalyst.

A ninth aspect includes the process of any of the first through eighth aspects in which the aromatization catalysts comprises a gallium modified H-MFI type zeolite.

A tenth aspect includes the process of the ninth aspect in which the gallium modified H-MFI type zeolite comprises 1 to 3 weight percent gallium, or Zn, or La, or Co or Cr or Ce or Mo or Fe or Pt

An eleventh aspect includes the process of any of the second through tenth aspects in which the dehydrogenation catalyst comprises an active phase metal carried on a support containing an ultra-stable (US) Y-type zeolite, in which a portion of aluminum atoms of the framework of said USY zeolite thereof is substituted with one or more of zirconium, titanium and hafnium atoms.

A twelfth aspect includes the process of any of the second through tenth aspects in which the dehydrogenation catalyst comprises an active phase metal carried on a support containing a Beta zeolite, in which a portion of aluminum atoms of the framework of said Beta zeolite thereof is substituted with one or more of zirconium, titanium and hafnium atoms.

A thirteenth aspect includes the process of any of the second through tenth aspects in which the dehydrogenation catalyst comprises an active phase metal carried on a support containing a mordenite zeolite, in which a portion of aluminum atoms of the framework of said mordenitc zeolite thereof is substituted with one or more of zirconium, titanium and hafnium atoms.

A fourteenth aspect includes the process of any of the eleventh through thirteenth aspects in which the active phase metal is selected from Ru, Rh, Pd, Ag, Os, Ir, Pt, and Au.

A fifteenth aspect includes the process of any of the eleventh through thirteenth aspects in which the active phase metal is platinum, the support is alumina, and the USY zeolite is substituted with zirconium and titanium atoms.

A sixteenth aspect includes the process of any of the first through fifteenth aspects in which the isomerization reactor is operated at a temperature of 100 to 150° C., a pressure of 30 to 40 bar, and a hydrogen to hydrocarbon molar ratio of 0.03:1 to 2:1.

A seventeenth aspect includes the process of any of the first through sixteenth aspects in which the aromatization reactor is operated at a temperature of 500 to 600° C. and a pressure of 0.5 to 5 bar.

An eighteenth aspect includes the process of any of the second through seventeenth aspects in which the dehydrogenation reactor is operated at a temperature of 525 to 625° C., a pressure of 1 to 8 bar, and a hydrogen to hydrocarbon molar ratio of 1:1 to 5:1.

It should be apparent to those skilled in the art that various modifications and variations can be made to the described embodiments without departing from the spirit and scope of the claimed subject matter. Thus, it is intended that the specification cover the modifications and variations of the various described embodiments provided such modifications and variations come within the scope of the appended claims and their equivalents.

The singular forms “a”, “an” and “the” include plural referents, unless the context clearly dictates otherwise.

Throughout this disclosure ranges are provided. It is envisioned that each discrete value encompassed by the ranges are also included. Additionally, the ranges which may be formed by each discrete value encompassed by the explicitly disclosed ranges are equally envisioned. For brevity, the same is not explicitly indicated subsequent to each disclosed range and the present general indication is provided.

As used in this disclosure and in the appended claims, the words “comprise,” “has,” and “include” and all grammatical variations thereof are each intended to have an open, non-limiting meaning that does not exclude additional elements or steps.

What is claimed is:

1. An integrated process for conversion of a hydrocarbon stream comprising light naphtha to enhanced value products, the process comprising:
(i) providing the hydrocarbon stream comprising light naphtha to a first reactor;
(ii) passing the hydrocarbon stream through the first reactor, the first reactor being an isomerization reactor with an isomerization catalyst disposed therein in which the isomerization reactor is operated at a temperature of 100 to 150° C., a pressure of 30 to 40 bar, and a hydrogen to hydrocarbon molar ratio of 0.03:1 to 2:1 to generate an isomerate stream comprising at least 50% by weight iso-paraffins;
(iii) passing the isomerate from the first reactor through a second reactor, the second reactor being an aromatization reactor with an aromatization catalyst disposed therein 1 in which the aromatization reactor is operated at a temperature of 500 to 600° C. and a pressure of 0.5 to 5 bar to generate an aromatic rich stream; and
(iv) passing the aromatic rich stream to an aromatic recovery complex to separate the aromatic rich stream into an aromatic fraction, a raffinate fraction comprising unconverted paraffins, and an aromatic bottoms fraction comprising C9+ hydrocarbons, where the aromatic fraction comprises benzene, toluene and mixed xylenes.

2. The process of claim 1 in which the process further comprises:
passing the isomerate from the first reactor through a dehydrogenation reactor with a dehydrogenation catalyst disposed therein to generate a dehydrogenated isomerate stream; and
passing the dehydrogenated isomerate stream through the second reactor in lieu of the isomerate from the first reactor through the second reactor.

3. The process of claim 1 in which the process further comprises recycling at least a portion of the raffinate fraction comprising unconverted paraffins back to the isomerization reactor.

4. The process of claim 1 in which the process further comprises recovering the aromatic bottoms fraction comprising C9+ hydrocarbons and sending aromatic bottoms fraction comprising C9+ hydrocarbons to a fuel oil or gasoline pool.

5. The process of claim 1 in which the hydrocarbon stream comprises at least 75% by weight of normal paraffins and iso-paraffins having 5 or 6 carbon atoms.

6. The process of claim 1 in which the process further comprises subjecting the hydrocarbon stream to a desulfurization operation prior to providing the hydrocarbon stream comprising light naphtha to the first reactor.

7. The process of claim 1 in which the hydrocarbon stream comprises less than 0.5 parts per million of sulfur by weight when provided to the first reactor.

8. The process of claim 1 in which the isomerization catalyst comprises a Pt on chlorinated alumina catalyst.

9. The process of claim 1 in which the isomerization catalyst comprises a Pt on sulfated zirconia catalyst.

10. The process of claim 1 in which the isomerization catalyst comprises a Pt on zeolitic catalyst.

11. The process of claim 1 in which the aromatization catalyst comprises a gallium modified H-MFI type zeolite.

12. The process of claim 11 in which the gallium modified H-MFI type zeolite comprises 1 to 3 weight percent gallium, or Zn, or La, or Co or Cr or Ce or Mo or Fe or Pt.

13. The process of claim 2 in which the dehydrogenation catalyst comprises an active phase metal carried on a support containing an ultra-stable (US) Y-type zeolite, in which a portion of aluminum atoms of the framework of said USY zeolite thereof is substituted with one or more of zirconium, titanium and hafnium atoms.

14. The process of claim 13 in which the active phase metal is selected from Ru, Rh, Pd, Ag, Os, Ir, Pt, and Au.

15. The process of claim 13 in which the active phase metal is platinum, the support is alumina, and the USY zeolite is substituted with zirconium and titanium atoms.

16. The process of claim 2 in which the dehydrogenation catalyst comprises an active phase metal carried on a support containing a Beta zeolite, in which a portion of aluminum atoms of the framework of said Beta zeolite thereof is substituted with one or more of zirconium, titanium and hafnium atoms.

17. The process of claim 2 in which the dehydrogenation catalyst comprises an active phase metal carried on a support containing mordenite zeolite, in which a portion of aluminum atoms of the framework of said mordenite zeolite thereof is substituted with one or more of zirconium, titanium and hafnium atoms.

18-19. (canceled)

20. The process of claim 2 in which the dehydrogenation reactor is operated at a temperature of 525 to 625° C., a pressure of 1 to 8 bar, and a hydrogen to hydrocarbon molar ratio of 1:1 to 5:1.
